(19) United States
(12) Patent Application Publication
(10) Pub. No.: US 2019/0306704 A1
(43) Pub. Date: Oct. 3, 2019

(54) WIRELESS COMMUNICATION SYSTEM AND WIRELESS COMMUNICATION DEVICE

(71) Applicant: Panasonic Intellectual Property Management Co., Ltd., Osaka (JP)

(72) Inventors: Nobuhiko ARASHIN, Osaka (JP); Akira YAMASAKI, Osaka (JP)

(21) Appl. No.: 16/444,640

(22) Filed: Jun. 18, 2019

Related U.S. Application Data
(63) Continuation of application No. PCT/JP2017/046277, filed on Dec. 25, 2017.

(30) Foreign Application Priority Data
Feb. 1, 2017 (JP) 2017-016852

(51) Int. Cl. H04W 12/00; H04W 76/10; H04W 12/04; H04W 40/24

(52) U.S. Cl. CPC H04W 12/0017; H04W 40/244; H04W 12/04071; H04W 76/10

(57) ABSTRACT

A first wireless communication device includes: a first communication unit; and a first addition unit that adds first additional information to a connection signal. A second wireless communication device includes: a second communication unit; and a second addition unit that adds second additional information that differs from the first additional information to a connection request signal requesting connection with the first wireless communication device. The second communication unit transmits to the first wireless communication device the connection request signal with the second additional information added when the second communication unit receives from the first communication unit the connection signal with the first additional information added. Then, the first communication unit transmits to the second wireless communication device a connection response signal for responding to the connection request signal and receives data from the second wireless communication device when the first communication unit receives from the second communication unit the connection request signal with the second additional information added.

### TECHNICAL FIELD

The present disclosure relates to a wireless communication system and wireless communication devices.

### BACKGROUND ART

In the conventional wireless communication system disclosed in PTL 1, a wireless surveillance camera constantly transmits beacon signals. The beacon signals are connection signals.

### CITATION LIST

### Patent Literature

PTL 1: Unexamined Japanese Patent Publication No. 2009-219083

### SUMMARY

The present disclosure provides a wireless communication system and wireless communication devices for improving communication reliability in data communication using radio transmission.

A wireless communication system in the present disclosure includes: a first wireless communication device that receives data; and a second wireless communication device that transmits data. The first wireless communication device includes: a first communication unit that wirelessly communicates with the second wireless communication device; and a first addition unit that adds first additional information to a connection signal for performing connection. The second wireless communication device includes: a second communication unit that wirelessly communicates with the first wireless communication device; and a second addition unit that adds second additional information that differs from the first additional information to a connection request signal requesting connection with the first wireless communication device. The second communication unit transmits to the first wireless communication device the connection request signal with the second additional information added when the second communication unit receives from the first communication unit the connection signal with the first additional information added. Then, the first communication unit transmits to the second wireless communication device a connection response signal for responding to the connection request signal and receives data from the second wireless communication device when the first communication unit receives from the second communication unit the connection request signal with the second additional information added.

Further, a wireless communication device in the present disclosure is a wireless communication device that receives data from a data transmission device, including: a communication unit that wirelessly communicates with the data transmission device; and an addition unit that adds first additional information to a connection signal for performing connection. When the communication unit transmits the connection signal with the first additional information added and subsequently receives from the data transmission device a connection request signal with second additional information added, the second additional information differing from the first additional information, after the communication unit, the communication unit transmits to the data transmission device a connection response signal for responding to the connection request signal and receives data from the data transmission device.

Further, another wireless communication device in the present disclosure is a wireless communication device that transmits data to a data reception device, including: a communication unit that wirelessly communicates with the data reception device; and an addition unit that adds second additional information to a connection request signal requesting connection with the data reception device. The communication unit transmits to the data reception device the connection request signal with the second additional information added by the addition unit when the communication unit receives from the data reception device a connection signal with first additional information added, the first additional information differing from the second additional information. Then, the communication unit transmits data to the data reception device when the communication unit receives from the data reception device a connection response signal for responding to the connection request signal.

The wireless communication system and the wireless communication devices in the present disclosure can improve communication reliability in data communication using radio transmission.

### BRIEF DESCRIPTION OF DRAWINGS

FIG. 1 is a lateral view illustrating one example of an outer appearance of wireless communication system 1 pertaining to a first exemplary embodiment.

FIG. 2 is a block diagram illustrating one example of data reception device 10 in wireless communication system 1 pertaining to the first exemplary embodiment.

FIG. 3 is a block diagram illustrating one example of data transmission device 20 in wireless communication system 1 pertaining to the first exemplary embodiment.

FIG. 4 is a sequence diagram illustrating one example of an operation of wireless communication system 1 pertaining to the first exemplary embodiment.

FIG. 5 is a flow diagram illustrating one example of an operation of data reception device 10 in wireless communication system 1 pertaining to the first exemplary embodiment.

FIG. 6 is a flow diagram illustrating one example of an operation of data transmission device 20 in wireless communication system 1 pertaining to the first exemplary embodiment.

FIG. 7 is a lateral view illustrating one example of an outer appearance of conventional wireless communication system 2.

FIG. 8 is a sequence diagram illustrating one example of an operation of conventional wireless communication system 2.

FIG. 9 is a block diagram illustrating one example of data reception device 50 in wireless communication system 3 pertaining to a second exemplary embodiment.

FIG. 10 is a block diagram illustrating one example of data transmission device 60 in wireless communication system 3 pertaining to the second exemplary embodiment.

FIG. 11 is a sequence diagram illustrating one example of an operation of wireless communication system 3 pertaining to the second exemplary embodiment.

FIG. 12 is a flow diagram illustrating one example of an operation of data reception device 50 in wireless communication system 3 pertaining to the second exemplary embodiment.

FIG. 13 is a flow diagram illustrating one example of an operation of data transmission device 60 in wireless communication system 3 pertaining to the second exemplary embodiment.

FIG. 14 is a lateral view illustrating one example of an outer appearance of wireless communication system 4 pertaining to a third exemplary embodiment.

FIG. 15 is a top view illustrating one example of an outer appearance of wireless communication system 4 pertaining to the third exemplary embodiment.

FIG. 16 is a sequence diagram illustrating one example of an operation of wireless communication system 5 pertaining to a fourth exemplary embodiment.

### DESCRIPTION OF EMBODIMENTS

Exemplary embodiments are described in detail below with reference to the drawings as appropriate. However, description that is more detailed than necessary may be omitted. For example, detailed description of well-known matters and redundant description of structures that are substantially the same may be omitted. This is for avoiding the following description from becoming unnecessarily redundant and for facilitating understanding by those skilled in the art.

The accompanying drawings and the following description are provided to enable those skilled in the art to fully understand the present disclosure and are not intended to limit the subject matter set forth in the claims by the accompanying drawings and the following description.

### First Exemplary Embodiment

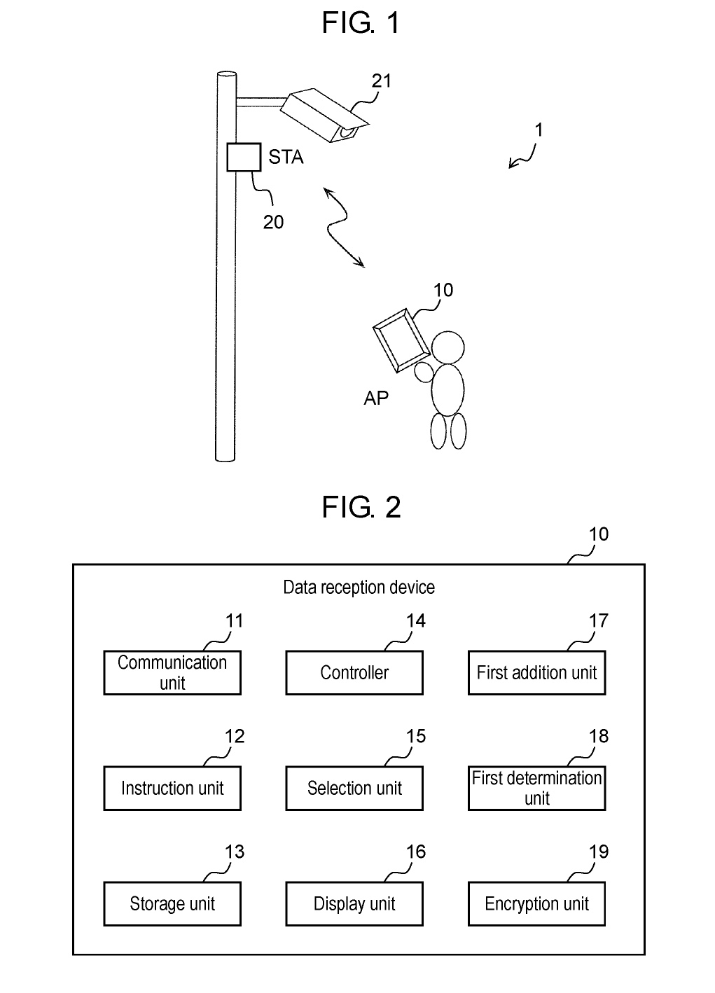

The present exemplary embodiment is described below with reference to FIGS. 1 to 8.

### [1-1. Configuration]

FIG. 1 is a lateral view illustrating one example of an outer appearance of wireless communication system 1 pertaining to the first exemplary embodiment.

In FIG. 1, wireless communication system 1 includes: data reception device 10 (one example of a first wireless communication device); data transmission device 20 (one example of a second wireless communication device); and photography device 21.

Data reception device 10 is an access point terminal (AP) having a wireless communication function. For example, data reception device 10 is a communication device such as a personal computer (PC), a tablet, or a smartphone. Due to this, data reception device 10 performs connection processing with data transmission device 20 by transmitting beacon signals, which are connection signals, to data transmission device 20. Then, in response to a user operating data reception device 10 after completion of connection processing, data reception device 10 can download photographic data stored in data transmission device 20.

Data transmission device 20 is a wireless communication terminal (STA) having a wireless communication function. Due to this, data transmission device 20 receives a beacon signal, which is a connection signal, from data reception device 10. Then, data transmission device 20 can transmit photographic data stored in data transmission device 20 to data reception device 10 by completing connection processing.

Photography device 21 is a surveillance camera for example, and converts images photographed by photography device 21 into data and transmits the data to data transmission device 20. Photography device 21 is connected to data transmission device 20 via a local area network (LAN) cable, for example. Photography device 21 may receive power supply from data transmission device 20 via the LAN cable. Note that photography device 21 may be built into data transmission device 20 as a photography unit.

Note that it is beneficial to install data transmission device 20 to a pole on the street, at an entrance of a store, in the premises of a station, or the like for example, at a height out of reach of ordinary people. This is a measure for preventing data transmission device 20, in which photographic data is stored, from being destroyed by passers-by and for preventing photographic data in data transmission device 20 from being stolen. Security can be improved by installing data transmission device 20 in such a manner. In particular, when photography device 21 is a surveillance camera, photographic data stored in data transmission device 20 is photographic data capturing a street and is secret data randomly capturing people, etc. Due to this, it is beneficial to install data transmission device 20 at a height out of reach of ordinary people taking problems such as privacy into consideration.

Next, FIG. 2 is a block diagram illustrating one example of data reception device 10 in wireless communication system 1 pertaining to the present exemplary embodiment.

In FIG. 2, data reception device 10 includes: communication unit 11 (one example of a first communication unit); instruction unit 12; storage unit 13; controller 14; selection unit 15; display unit 16; first addition unit 17; first determination unit 18; and encryption unit 19.

Communication unit 11 transmits and receives packets by wireless communication methods. For example, Wireless Gigabit (WiGig) (registered trademark) and Wi-Fi (registered trademark) may be used as wireless communication methods. Due to this, communication unit 11 transmits and receives WiGig packets in WiGig communication, and transmits and receives Wi-Fi packets in Wi-Fi communication. Note that each wireless communication method is realized by providing each of an antenna for transmitting and receiving radio signals and a radio signal control circuit. Due to this, communication unit 11 may include a WiGig communication unit and a Wi-Fi communication unit. Further, a configuration may be adopted such that parts that can be shared between the WiGig communication unit and the Wi-Fi communication unit are shared.

Here, description is provided of WiGig and Wi-Fi.

WiGig has a high frequency band (the 60 GHz band). Due to this, WiGig has a rectilinear propagation property, and is a wireless communication method that has directivity. Further, WiGig radio waves do not pass through shielding objects such as walls and windows and easily attenuate, and thus, have a small, limited communication range.

In contrast, Wi-Fi has relatively low frequency bands (the 2.4 GHz band, the 5 GHz band, etc.). Due to this, Wi-Fi is a wireless communication method that does not have directivity. Further, Wi-Fi radio waves pass through shielding objects such as walls and windows and have a larger communication range than WiGig does.

Instruction unit 12 accepts an instruction from a user. For example, instruction unit 12 is a touch panel disposed on display unit 16. In this case, an instruction from a user is a touch operation performed by a user on the touch panel, for example. Instruction unit 12 may be a switch or the like that accepts an instruction from a user.

Storage unit 13 stores photographic data received from data transmission device 20 via communication unit 11. Specifically, storage unit 13 is configured by using a storage device such as a read only memory (ROM), a random access memory (RAM), or the like.

Controller 14 controls data reception device 10, and controls communication unit 11 and storage unit 13, for example. Specifically, controller 14 controls the reception, via communication unit 11, of photographic data transmitted from data transmission device 20, the storage to storage unit 13 of photographic data transmitted from data transmission device 20 via communication unit 11, and the like.

Further, when instruction unit 12 accepts an instruction from a user, controller 14 makes communication unit 11 transmit a beacon signal. Specifically, when a user would like to acquire photographic data from data transmission device 20 for example, it is necessary to perform connection processing between data transmission device 20 and data reception device 10. In this case, data reception device 10 can transmit a beacon signal in response to the user operating instruction unit 12. Due to this, data reception device 10 can start connection processing with data transmission device 20.

Note that communication unit 11 may transmit, to data transmission device 20, a management information request signal in order to acquire management information of data transmission device 20. As a result of this, communication unit 11 can acquire management information of data transmission device 20. Then, storage unit 13 may store photographic data that a user has selected from the management information.

Selection unit 15, based on the management information, which is received from communication unit 11, presents information so that a user can perform a selection and returns, to data transmission device 20, information that the user has selected. For example, when instruction unit 12 is a touch panel, display unit 16 displays, based on the management information, a list having checkboxes. Then, selection unit 15, in response to a user putting a checkmark in a checkbox, returns, to data transmission device 20, the photographic data that has been provided with a checkmark. Note that when the management information includes images such as thumbnails, corresponding images may be displayed along with the checkboxes.

Note that, by providing display unit 16 in data reception device 10, controller 14 may issue an instruction of transmission of a beacon signal with respect to data transmission device 20. Alternatively, display unit 16 may be configured to display a list. Further, display unit 16 may display data that a user has selected on instruction unit 12.

First addition unit 17 adds first additional information to beacon signals to be transmitted to data transmission device 20.

First determination unit 18 determines whether or not second additional information is added to a connection request signal received from data transmission device 20.

Encryption unit 19 encrypts the second additional information when first determination unit 18 determines that the second additional information is added to the connection request signal.

All or some of controller 14, selection unit 15, first addition unit 17, first determination unit 18, and encryption unit 19 described above may be realized by an integrated circuit, or may be realized by an integrated circuit executing a program stored in storage unit 13.

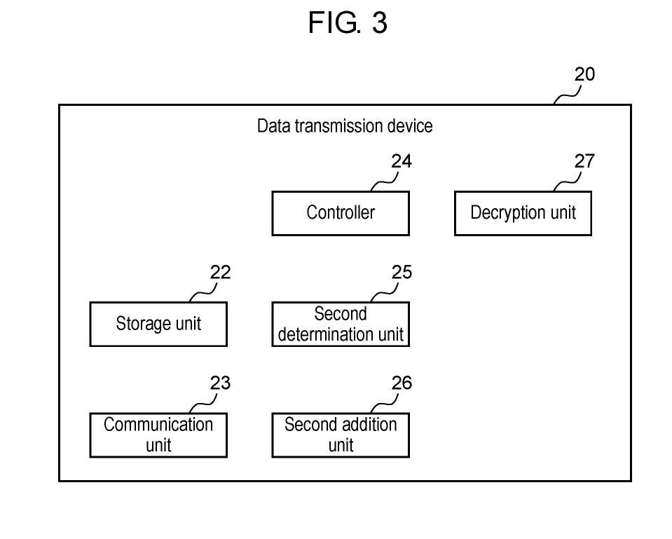

Next, FIG. 3 is a block diagram illustrating one example of data transmission device 20 in wireless communication system 1 pertaining to the first exemplary embodiment.

In FIG. 3, data transmission device 20 includes: storage unit 22; communication unit 23 (one example of a second communication unit); controller 24; second determination unit 25; second addition unit 26; and decryption unit 27.

Storage unit 22 stores image data acquired from photography device 21 (see FIG. 1). Specifically, storage unit 22 is configured by using a storage device such as a ROM, a RAM, or the like.

Communication unit 23 has a configuration similar to that of communication unit 11 in data reception device 10, and thus, description of details of communication unit 23 is omitted. Communication unit 23 can receive photographic data of photography device 21 in LAN packets.

Controller 24 controls communication unit 23 and storage unit 22. Specifically, controller 24 controls the storage to storage unit 22 of photographic data photographed by photography device 21, the transmission of photographic data that is stored to storage unit 22 to data reception device 10 via communication unit 23, and the like. Controller 24 is configured of an arithmetic unit, software that is executed on the arithmetic unit, and the like.

Further, communication unit 23 may receive a management information request signal from data reception device 10 and transmit requested management information to data reception device 10. Here, the management information is a list of photographic data photographed by photography device 21 and stored in storage unit 22. Specifically, the management information is list information constituted of a camera ID (the name of a camera, the production serial number of the camera, or the like), dates and times, etc., and may include thumbnail images.

Second determination unit 25 determines whether or not the first additional information is added to a beacon signal received from data reception device 10. Further, second determination unit 25 determines whether or not information decrypted by decryption unit 27 is the second additional information.

Second addition unit 26 adds second additional information to beacon signals to be transmitted to data reception device 10.

Decryption unit 27 decrypts encrypted second additional information added to a connection response signal received from data reception device 10.

Further, communication unit 23 may receive selection information requested by data reception device 10 and transmit, to data reception device 10, photographic data selected from photographic data stored in storage unit 22.

Here, the selection information is information that a user has selected from the list information on data reception device 10. The user may select one piece of photographic data (one item) from the list information, may select a plurality of pieces of photographic data, or may select all pieces of photographic data.

All or some of controller 24, second determination unit 25, second addition unit 26, and decryption unit 27 described above may be realized by an integrated circuit, or may be realized by an integrated circuit executing a program stored in storage unit 22.

### [1-2. Operations]

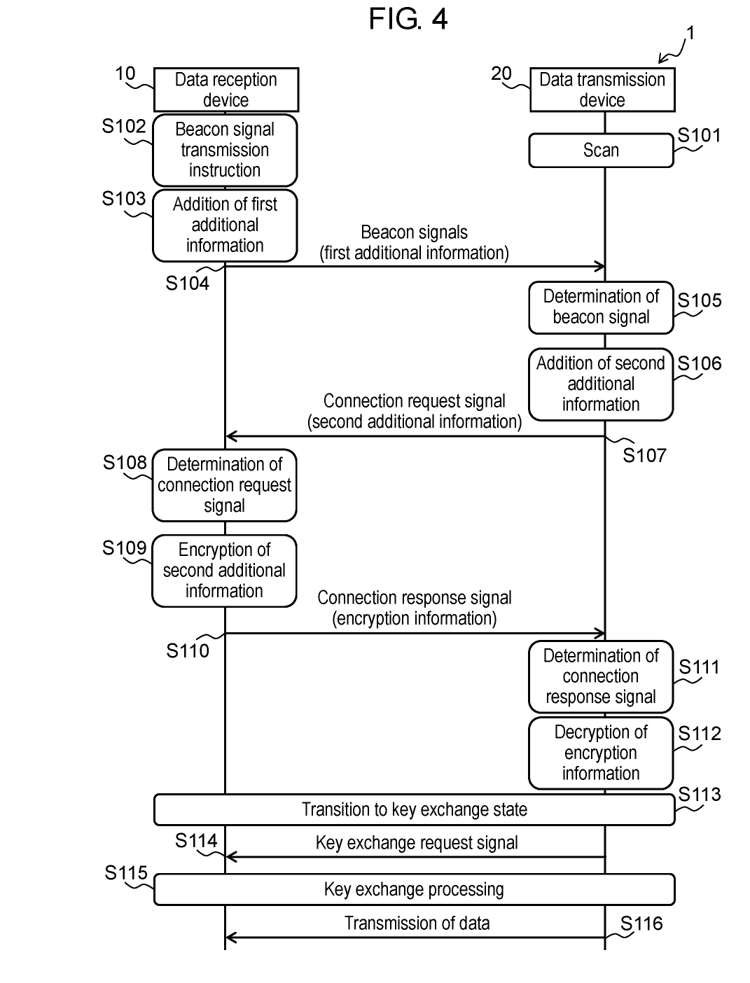

FIG. 4 is a sequence diagram illustrating one example of an operation of wireless communication system 1 pertaining to the first exemplary embodiment.

Communication unit 23 is activated in data transmission device 20. Then, communication unit 23 performs a scan in order to check whether or not beacon signals are being transmitted from data reception device 10 (S101). Note that it is beneficial that the scan be performed at one second intervals or the like, for example. Specifically, the following process may be repeated; the scan is performed in the order of 2ch, 3ch, and the scan is performed again after a waiting time of one second.

Meanwhile, when instruction unit 12 accepts an instruction from a user in data reception device 10, controller 14 issues an instruction for transmitting beacon signals to data transmission device 20 (S102). Then, in data reception device 10, first addition unit 17 adds the first additional information to the beacon signals (S103). Then, communication unit 11 transmits the beacon signals (S104). Here, note that the beacon signals are transmitted by broadcasting. Here, the timing at which controller 14 issues the instruction may be when instruction unit 12 receives the instruction from the user, may be when the power of data reception device 10 is turned on, or may be when an application for receiving photographic data is started.

The beacon signals transmitted in the first exemplary embodiment have the first additional information added to the beacon signals. This first additional information is specific information that data reception device 10 has that can be analyzed in data transmission device 20, and for example, is a hash value generated by combining a media access control (MAC) address of data reception device 10, etc., or the like. Note that the first additional information may be information that data reception device 10 has, or may be information having been processed by data reception device 10.

Note that the first additional information added to the beacon signals is transmitted after the beacon signals or before the beacon signals, for example. That is, the first additional information added to the beacon signals is information independent from the beacon signals.

When communication unit 23 receives a beacon signal transmitted from data reception device 10, second determination unit 25 of data transmission device 20 performs determination of the first additional information included in the beacon signal (S105). According to the result at second determination unit 25, second addition unit 26 adds the second additional information to a connection request signal (S106). Then, communication unit 23 transmits, to data reception device 10, the connection request signal with the second additional information added (S107).

The connection request signal transmitted in the present exemplary embodiment includes the second additional information. This second additional information is specific information that data transmission device 20 has that can be encrypted in data reception device 10, and for example, is information yielded by encrypting any data generated by data transmission device 20, or the like. Note that the second additional information is information differing from the first additional information.

Note that the second additional information added to the connection request signal is transmitted after the connection request signal or before the connection request signal, for example.

When communication unit 11 receives a connection request signal transmitted from data transmission device 20, first determination unit 18 determines whether or not second additional information is added to the connection request signal (S108). According to the result of the determination by first determination unit 18, encryption unit 19 encrypts the second additional information included in the connection request signal (S109). Then, communication unit 11 transmits, to data transmission device 20, a connection response signal with the encrypted second additional information (encryption information) added (S110).

Note that the encryption information is not limited to encrypted information, and may be information yielded by processing the second additional information. For example, the encryption information may be information relating to the second additional information that is generated by using information that data reception device 10 has and the second additional information.

When communication unit 23 receives a connection response signal transmitted from data reception device 10, second determination unit 25 determines whether or not encrypted second additional information (encryption information) is added to the connection response signal (S111). Then, decryption unit 27 decrypts the encrypted second additional information (encryption information) included in the connection response signal (S112). That is, decryption unit 27 decrypts the encryption information and generates decrypted information. According to the result yielded by decrypting the encrypted second additional information (encryption information), data transmission device 20 transitions to a state for performing key exchange with data reception device 10 (S113). Second determination unit 25 determines whether or not the result yielded by decrypting the encrypted second additional information (encryption information) matches the information having been added as the second additional information. Then, in accordance with the result of the determination, data transmission device 20 transitions to the state for performing key exchange with data reception device 10. That is, data transmission device 20 transitions to the key exchange state when the second additional information having been added by second addition unit 26 and the decrypted information generated by decryption unit 27 match.

Further, when the encryption information is information relating to the second additional information that is generated by using information that data reception device 10 has and the second additional information, data transmission device 20 separates the information that data reception device 10 has and the second additional information. It suffices for data transmission device 20 to then transition to the state for performing key exchange with data reception device 10 in accordance with whether the separated second additional information matches the second additional information having been added.

Then, communication unit 23 transmits, to data reception device 10, a key exchange request signal for encrypting communication data in the wireless section (S114). Data transmission device 20 having been made to transition to the state for performing key exchange performs key exchange processing with data reception device 10 to which the key exchange request is transmitted (S115).

For example, key exchange processing such as 4way-HandShake may be used as this key exchange processing.

After the completion of key exchange processing, data transmission device 20 transmits photographic data as encrypted data to data reception device 10 via communication unit 23 (S116). Here, the photographic data is stored in storage unit 22. Due to this, data reception device 10 receives, via communication unit 11, the photographic data as encrypted data from data transmission device 20, and stores the photographic data to storage unit 13.

Note that WiGig SD Extension (WSD), which is encrypted communication between devices, may be used for transmission of photographic data by data transmission device 20 or reception of the photographic data by data reception device 10.

Further, a configuration may be made such that, from when key exchange processing is started until when connection with data reception device 10 is terminated, data transmission device 20 does not accept reception of signals from devices other than the data reception device with which connection processing is performed. That is, a configuration may be made such that, from when transmission of a key exchange request signal is started until when transmission of photographic data is completed, data transmission device 20 does not accept signals from devices other than data reception device 10.

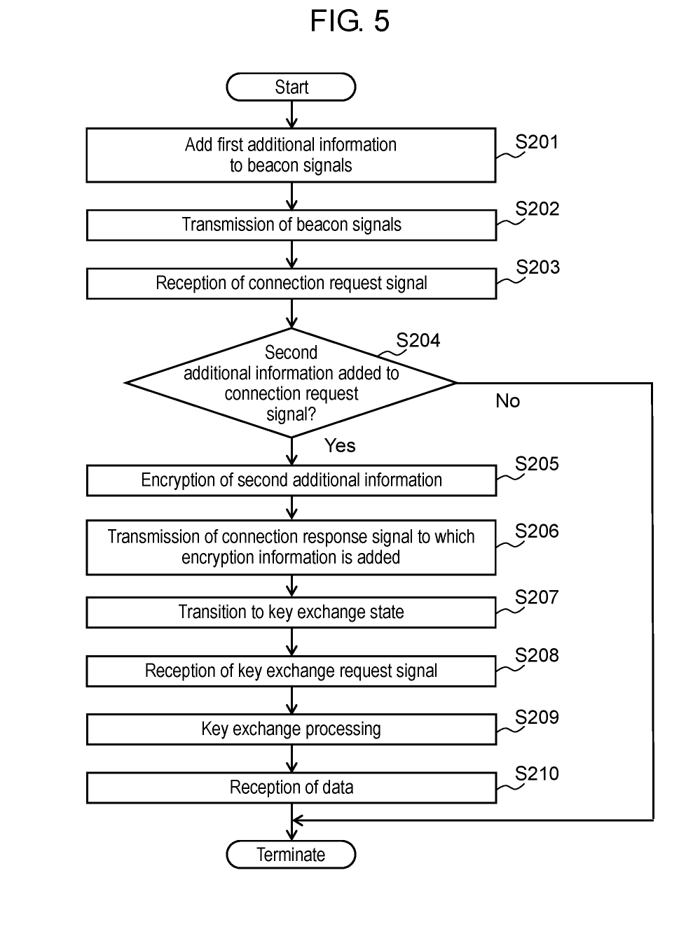

Next, FIG. 5 is a flow diagram illustrating one example of an operation of data reception device 10 in wireless communication system 1 pertaining to the present exemplary embodiment.

First, in order to perform communication with data transmission device 20, communication unit 11 accepts an instruction to transmit beacon signals. First addition unit 17 adds the first additional information to the beacon signals (S201). In data reception device 10, communication unit 11 transmits, to data transmission device 20, the beacon signals with the first additional information added (S202).

Then, communication unit 11 receives a connection request signal transmitted from data transmission device 20 (S203).

After communication unit 11 receives the connection request signal, first determination unit 18 determines whether second additional information, which is data transmission device 20-side additional information, is added to the connection request signal (S204). When second additional information is added to the connection request signal (Yes in S204), encryption unit 19 of data reception device 10 encrypts the second additional information (S205). On the other hand, when second additional information is not added to the connection request signal (No in S204), no response is made to the connection request signal.

After the second additional information is encrypted, communication unit 11 transmits, to data transmission device 20, a connection response signal with information yielded by encrypting the second additional information (encryption information) added (S206).

Then, communication unit 11 transitions to a key exchange state (S207). Then, communication unit 11 receives a key exchange request signal (S208). Then, data reception device 10 performs key exchange processing with data transmission device 20 (S209). After key exchange processing is completed, communication unit 11 receives data from data transmission device 20 (S210).

Note that, when key exchange processing fails, a transition to a connection request wait state is performed.

Then, after the reception of data is completed, data reception device 10 terminates the sequence of processing pertaining to the transmission of beacon signals.

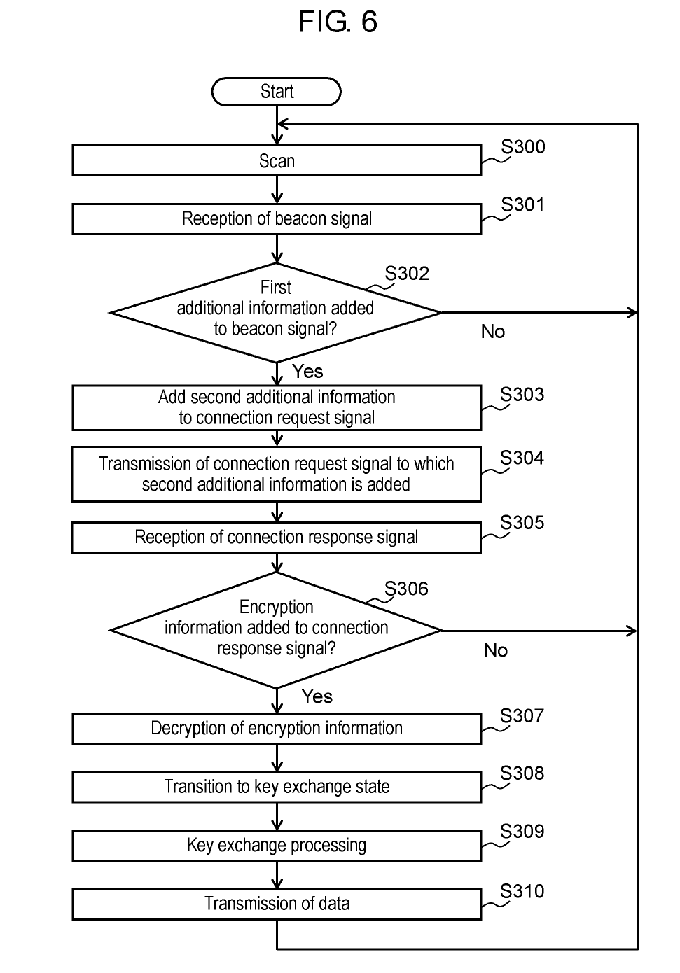

Next, FIG. 6 is a flow diagram illustrating one example of an operation of data transmission device 20 in wireless communication system 1 pertaining to the present exemplary embodiment.

First, in order that beacon signals from data reception device 10 can be received at any time, communication unit 23 occasionally performs a scan in order to check whether beacon signals are being transmitted from data reception device 10 (S300). Then, data transmission device 20 receives a beacon signal through the scan (S301). Note that when a beacon signal is not received, data transmission device 20 performs the scan for receiving a beacon signal again after an interval of time.

When communication unit 23 receives a beacon signal, second determination unit 25 in data transmission device 20 determines whether first additional information, which is information added at data reception device 10-side, is added to the beacon signal (S302). Note that when first additional information is not added to the beacon signal (No in S302), processing returns to step S300. Then, communication unit 23 performs the scan for receiving a beacon signal again after an interval of time.

When the first additional information is added to the beacon signal (Yes in S302), second addition unit 26 in data transmission device 20 adds second additional information, which is information specific to data transmission device 20, to a connection request signal (S303). Then, communication unit 23 transmits, to data reception device 10, the connection request signal with the second additional information added (S304).

Then, communication unit 23 receives a connection response signal (S305). Note that when a connection request signal is not received, communication unit 23 may perform the scan for receiving a beacon signal again after an interval of time.

After the connection response signal is received, second determination unit 25 in data transmission device 20 determines whether or not encrypted second additional information (encryption information) is added to the connection response signal (S306). Note that, when encryption information is not added to the connection response signal (No in S306), communication unit 23 returns to step S300 and performs the scan for receiving a beacon signal again.

When encryption information is added to the connection response signal (Yes in S306), decryption unit 27 performs authentication for decrypting the encryption information and performs decryption processing (S307). Note that when the decryption fails, communication unit 23 may perform the scan for receiving a beacon signal again after an interval of time, for example.

When the decryption succeeds, data transmission device 20 transitions to a state for performing key exchange processing (S308). Then, data transmission device 20 performs key exchange processing (S309). Note that when key exchange processing fails, communication unit 23 may perform the scan for receiving a beacon signal again.

When key exchange processing succeeds, data transmission device 20 transmits photographic data to data reception device 10 (S310). Then, processing returns to step S300, and communication unit 23 performs the scan again.

### [1-3. Effects, Etc.]

First, description is provided of a conventional wireless communication system in a surveillance camera.

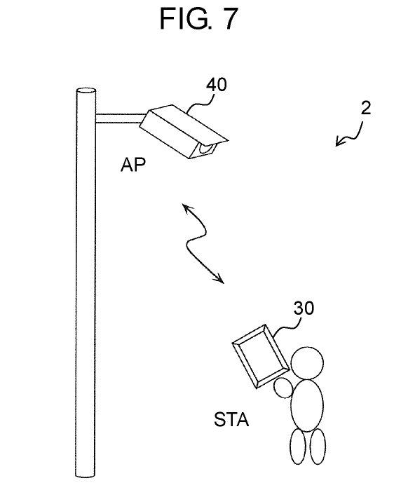

FIG. 7 is a lateral view illustrating one example of an outer appearance of conventional wireless communication system 2 in a surveillance camera.

In conventional wireless communication system 2, data reception device 30 is a wireless communication terminal (STA) having a wireless communication function, and data transmission device 40 is an access point terminal (AP) having a wireless communication function.

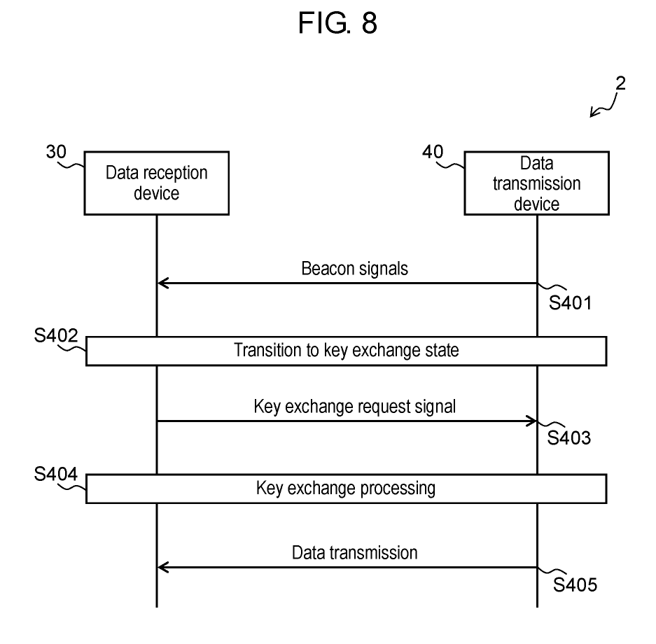

FIG. 8 is a sequence diagram illustrating one example of an operation of conventional wireless communication system 2.

First, data transmission device 40 occasionally transmits beacon signals (S401).

When data reception device 30 receives a beacon signal transmitted from data transmission device 40, data reception device 30 performs communication control based on communication information acquired from the beacon signal. Then, data reception device 30 and data transmission device 40 transition to key exchange states (S402).

Next, data reception device 30 transmits a key exchange request signal to data transmission device 40 (S403). Then, key exchange processing is performed between data reception device 30 and data transmission device 40 (S404).

When key exchange processing is completed, data transmission device 40 transmits photographic data to data reception device 30 (S405).

In such a manner, in conventional wireless communication system 2, data transmission device 40 transmits beacon signals and transitions to connection processing with data reception device 30. Such a configuration, however, gives rise to a risk of data transmission device 40 unfortunately performing connection processing with different data reception device 30 to which photographic data should not be transmitted, a risk of information of data transmission device 40 regarding connection being intercepted by others, etc. That is, reliability becomes a problem.

In view of this, in wireless communication system 1 in the present exemplary embodiment, data transmission device 20 is a wireless communication terminal having a wireless communication function, and data reception device 10 is an access point terminal having a wireless communication function. Due to this, unlike conventional wireless communication system 2, data transmission device 20 does not occasionally transmit beacon signals in order to receive a connection request signal from data reception device 10. That is, conventional data reception device 30 does not receive any beacon signal from data transmission device 20, and it is difficult for conventional data reception device 30 to wirelessly communicate with data transmission device 20. In other words, with the exception of data reception device 10, wireless communication with data transmission device 20 is difficult. Due to this, reliability can be improved with wireless communication system 1 in the present exemplary embodiment.

Further, first addition unit 17 in data reception device 10 adds the first additional information to beacon signals. Further, data transmission device 20 determines whether or not the first additional information is added to a beacon signal transmitted by data reception device 10. That is, connection processing with data transmission device 20 cannot be performed, with the exception of data reception device 10, which transmits beacon signals with the first additional information added. Further, even if a conventional wireless communication device can recognize that beacon signals are present, it is difficult for the conventional wireless communication devices to recognize that the first additional information is added. Due to this, data transmission device 20 in the present exemplary embodiment is capable of suppressing connection with wireless communication devices other than data reception device 10. Due to this, reliability can be improved with wireless communication system 1 in the present exemplary embodiment.

Further, in wireless communication system 1 in the first exemplary embodiment, data reception device 10 determines whether or not the second additional information is added to a connection request signal. That is, connection processing with data reception device 10 cannot be performed, with the exception of data transmission device 20, which transmits a connection request signal with the second additional information added. Due to this, data transmission device 20 in the present exemplary embodiment is capable of suppressing connection with wireless communication devices other than data reception device 10. Due to this, reliability can be improved with wireless communication system 1 in the present exemplary embodiment.

In particular, in the present exemplary embodiment, data transmission device 20 determines whether or not the first additional information is added to a beacon signal, and data reception device 10 determines whether or not the second additional information is added to a connection request signal. Due to this, data transmission device 20 determines whether or not data reception device 10 is the connection target, and data reception device 10 also determines whether or not data transmission device 20 is the connection target. That is, specific data transmission device 20 and specific data reception device 10 mutually determine whether the other one of data transmission device 20 and data reception device 10 is the connection target. Due to this, in wireless communication system 1 in the present exemplary embodiment, transmission and reception of data can be performed among connection targets that are more reliable.

Further, in conventional wireless communication system 2, data transmission device 40 constantly transmits beacon signals, and data reception device 30 receives a beacon signal transmitted from data transmission device 40. With this configuration, unfortunately, there is a risk of interception of beacon signals transmitted from data transmission device 40. Further, it will be discovered that data transmission device 40 has a wireless function, and the guaranteeing of security becomes a problem.

In view of this, in the present exemplary embodiment, data transmission device 20 is a wireless communication terminal having a wireless communication function, and data reception device 10 is an access point terminal having a wireless communication function. Further, due to data reception device 10 having instruction unit 12, beacon signals are transmitted only when a user of data reception device 10 would like to receive image data. That is, in wireless communication system 1 in the present exemplary embodiment, data reception device 10 is capable of transmitting beacon signals when necessary. Further, data reception device 10 does not transmit beacon signals when unnecessary. Due to this, in wireless communication system 1 in the present exemplary embodiment, beacon signals are transmitted only during a specific period, and the interception of beacon signals by others can be suppressed. Due to this, reliability can be improved with wireless communication system 1 in the first exemplary embodiment.

Further, it is beneficial to use a wireless communication method having directivity as the wireless communication method between data reception device 10 and data transmission device 20 in wireless communication system 1. This is because the area in which beacon signals, photographic data, etc., can be transmitted and received can be limited by using a wireless communication method having directivity. Due to this, the interception of beacon signals by others can be suppressed to a further extent.

Further, a configuration may be made such that, from when key exchange processing is started in wireless communication system 1 until when connection with data reception device 10 is terminated, data transmission device 20 does not accept reception of signals from devices other than data reception device 10, with which connection processing is performed. Due to this, one-to-one communication is performed between one data reception device 10 and one data transmission device 20 in wireless communication system 1, and thus, data transmission device 20 is capable of preventing erroneous connection with other wireless communication devices, interference from other wireless communication devices, etc.

Further, communication unit 11 may transmit beacon signals, which are connection signals, to data transmission device 20 only when instruction unit 12 accepts an instruction from a user. Due to this, the period during which beacon signals are transmitted is limited by the user, and thus, the reliability in wireless communication can be improved to a further extent.

### Second Exemplary Embodiment

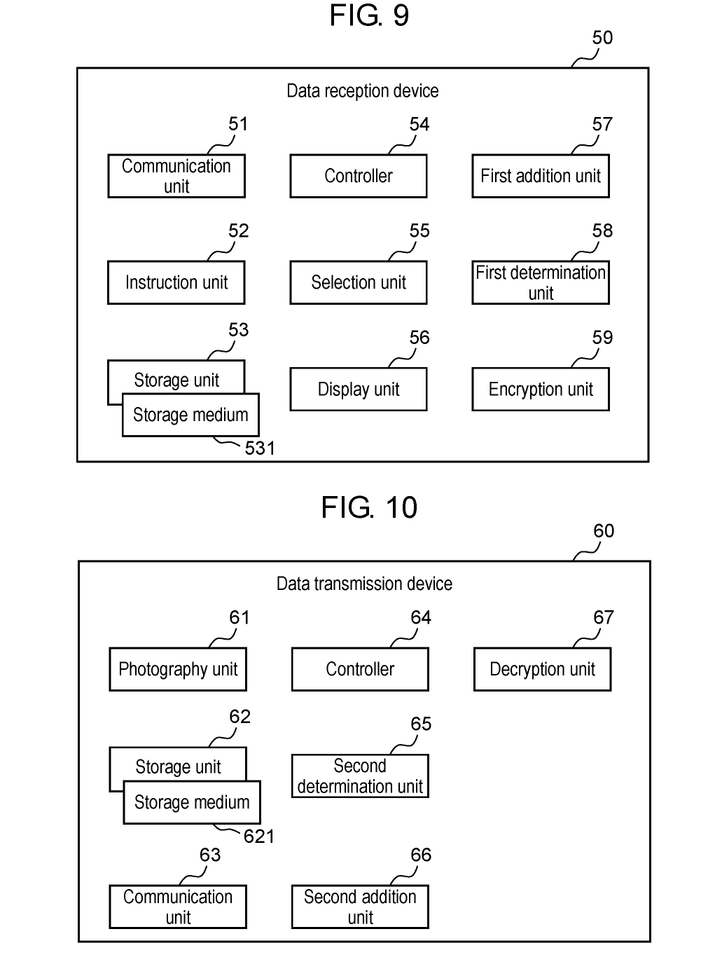

The present exemplary embodiment is described below with reference to FIGS. 9 to 13.

### [2-1. Configuration]

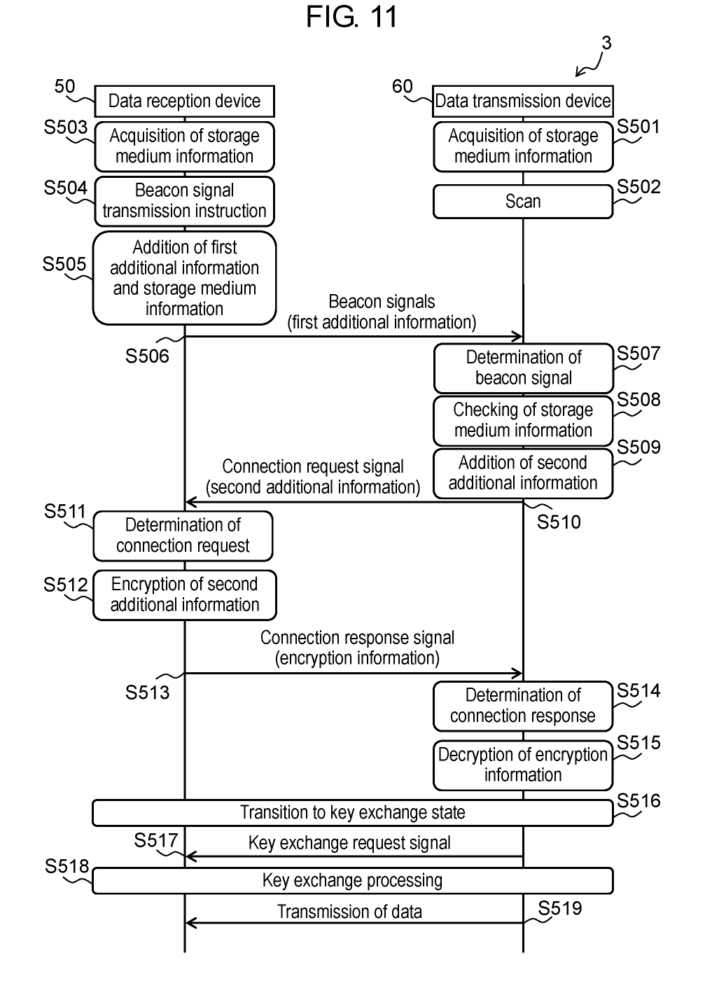

FIG. 9 is a block diagram illustrating one example of data reception device 50 in wireless communication system 3 (see FIG. 11) pertaining to the present exemplary embodiment. Data reception device 50 pertaining to the present exemplary embodiment differs from data reception device 10 pertaining to the first exemplary embodiment in that storage medium 531 is connected to storage unit 13 in FIG. 2. Thus, communication unit 51, instruction unit 52, storage unit 53, controller 54, selection unit 55, display unit 56, first addition unit 57, first determination unit 58, and encryption unit 59 in data reception device 50 pertaining to the present exemplary embodiment respectively have configurations similar to those of communication unit 11, instruction unit 12, storage unit 13, controller 14, selection unit 15, display unit 16, first addition unit 17, first determination unit 18, and encryption unit 19 in data reception device 10 pertaining to the first exemplary embodiment.

Storage medium 531 temporarily stores photographic data received from data transmission device 60, and has storage medium information (first storage medium information) for identifying the storage medium. Storage medium 531 is configured by using a storage device such as a Not-AND (NAND) flash memory.

FIG. 10 is a block diagram illustrating one example of data transmission device 60 in wireless communication system 3 pertaining to the present exemplary embodiment. Data transmission device 60 pertaining to the present exemplary embodiment differs from data transmission device 20 pertaining to the first exemplary embodiment in that storage medium 621 is connected to storage unit 22 in FIG. 3. Thus, storage unit 62, communication unit 63, controller 64, second determination unit 65, second addition unit 66, and decryption unit 67 in data transmission device 60 pertaining to the present exemplary embodiment respectively have configurations similar to those of storage unit 22, communication unit 23, controller 24, second determination unit 25, second addition unit 26, and decryption unit 27 in data transmission device 20 pertaining to the first exemplary embodiment. Further, in the present exemplary embodiment, data transmission device 60 differs from data transmission device 20 for including photography unit 61. Photography unit 61 has a configuration similar to that of photography device 21, but differs from photography device 21 in that photography unit 61 is built into data transmission device 60.

Storage medium 621 is capable of temporarily storing photographic data stored to storage unit 62, and has identification information (second storage medium information) capable of identifying storage medium 621. Further, storage medium 621 is configured by using a storage device such as a NAND flash memory, or the like. Note that data transmission device 60 may have an insertion slot into which and from which storage medium 621 can be inserted and removed. Further, data transmission device 60 need not have an insertion slot. Storage medium 621 may be embedded in storage unit 62.

### [2-2. Operations]

FIG. 11 is a sequence diagram illustrating one example of an operation of wireless communication system 3 pertaining to the present exemplary embodiment.

Controller 64 in data transmission device 60 acquires storage medium information from storage medium 621 in storage unit 62 (S501). Note that it suffices for controller 64 to acquire the storage medium information at a time point when storage medium 621 is inserted into storage unit 62, for example.

Next, controller 64 issues an instruction to activate communication unit 63. Then, when communication unit 63 receives the instruction from controller 64, communication unit 63 performs a scan in order to check whether beacon signals are being transmitted from data reception device 50 (S502). Note that it is beneficial that the scan be performed at 150 microsecond intervals or the like, for example. That is, communication unit 63 may repeat the following process, for example; the scan is performed in the order of 2ch, 3ch, and the scan is performed again after a waiting time of 150 microseconds.

On the other hand, controller 54 in data reception device 50 performs the acquisition of storage medium information with respect to storage medium 531 in storage unit 53 (S503). Note that it suffices for controller 54 to acquire the storage medium information at a time point when storage medium 531 is inserted into storage unit 53, for example.

Next, controller 54 issues an instruction for transmitting beacon signals to data transmission device 60 (S504). First addition unit 57 adds the first additional information and the storage medium information of storage medium 531 to the beacon signals (S505). Then, communication unit 51 transmits, to data transmission device 60, the beacon signals with the first additional information and the storage medium information of storage medium 531 added (S506).

Here, the timing at which controller 54 issues the instruction may be when instruction unit 52 receives an instruction from a user, may be when the power of data reception device 50 is turned on, or may be when an application is started.

The beacon signals in the present exemplary embodiment not only include the first additional information similarly to the first exemplary embodiment, but also include the storage medium information. This first additional information is information specific to data reception device 50 that can be analyzed in data transmission device 60, and for example, is a hash value generated by combining a MAC address of data reception device 50, etc., or the like. Note that the first additional information may be information that data reception device 50 has, or may be information having been processed by data reception device 50.

When communication unit 63 receives a beacon signal transmitted from data reception device 50, second determination unit 65 performs determination of first additional information included in the beacon signal (S507). Further, controller 64 checks whether the storage medium information of storage medium 531 included in the beacon signal and the storage medium information of storage medium 621, which has been acquired from storage unit 62, match (S508). Then, second addition unit 66 adds the second additional information to a connection request signal, according to the result of analysis of the first additional information and the result of checking of the storage medium information. Then, second communication unit 63 transmits, to data reception device 50, the connection request signal with the second additional information added (S510).

The second additional information is added to the connection request signal in the present exemplary embodiment, similarly to that in the first exemplary embodiment. This second additional information is information specific to data transmission device 60 that can be encrypted in data reception device 10, and for example, is information yielded by encrypting any data generated by data transmission device 60. Note that the second additional information is information differing from the first additional information.

Note that the second additional information added to the connection request signal is transmitted after the connection request signal or before the connection request signal, for example.

When communication unit 51 receives a connection request signal transmitted from data transmission device 60, first determination unit 58 determines whether or not second additional information is included in the connection request signal (S511). Then, encryption unit 59 encrypts the second additional information included in the connection request signal (S512). Then, communication unit 51 transmits, to data transmission device 60, a connection response signal with the encrypted second additional information (encryption information) added (S513).

Note that the encryption information is not limited to encrypted information, and may be information yielded by processing the second additional information. For example, the encryption information may be information relating to the second additional information that is generated by using information that data reception device 50 has and the second additional information.

When communication unit 63 receives a connection response signal transmitted from data reception device 50, second determination unit 65 determines whether or not encryption information is added to the connection response signal (S514). Then, decryption unit 67 decrypts the encryption information, according to the result of determination by second determination unit 65 (S515). Then, data transmission device 60 and data reception device 50 transition to states for performing key exchange (S516). Second determination unit 65 determines whether or not the result yielded by decrypting the encrypted second additional information (encryption information) matches the information having been added as the second additional information. Then, in accordance with the result of the determination, data transmission device 60 transitions to the state for performing key exchange with data reception device 50.

Further, when the encryption information is information relating to second additional information generated by using information that data reception device 50 has and the second additional information, data transmission device 60 separates the information that data reception device 50 has and the second additional information. Then, second determination unit 65 determines whether or not the separated second additional information matches the second additional information having been added. It suffices for data transmission device 60 to then transition to the state for performing key exchange with data reception device 50, in accordance with the result of the determination.

After the transition to the key exchange state, communication unit 63 transmits, to data reception device 50, a key exchange request signal for encrypting communication data in the wireless section (S517). Data transmission device 60 having been made to transition to the state for performing key exchange performs key exchange processing with data reception device 50 to which the key exchange request is transmitted (S518).

For example, key exchange processing such as 4way-HandShake may be used as this key exchange processing.

After the completion of key exchange processing, data transmission device 60 transmits photographic data stored in storage unit 62 via communication unit 63 (S519).

Data reception device 50 receives the photographic data from data transmission device 60 via communication unit 51, and stores the photographic data to storage unit 53.

Note that WiGig SD (WSD) Extension, which is encrypted communication between devices, may be used for transmission of photographic data by data transmission device 60 or reception of the photographic data by data reception device 50.

Further, a configuration may be made such that, from when key exchange processing is started until when connection with the data reception device is terminated, the data transmission device does not accept reception of signals from devices other than the data reception device with which connection processing is performed.

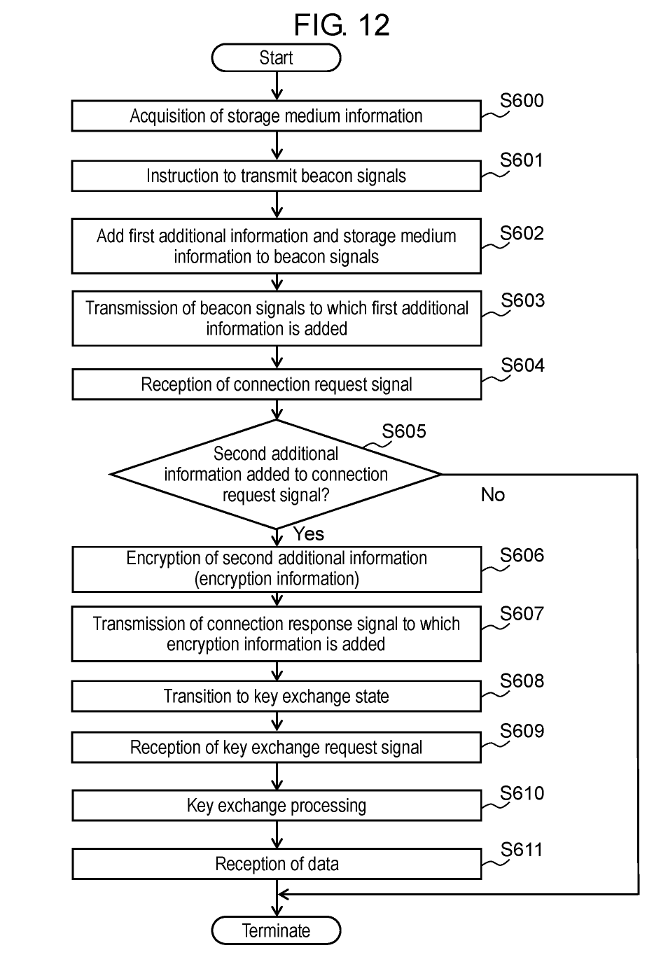

Next, FIG. 12 is a flow diagram illustrating one example of an operation of data reception device 50 in wireless communication system 3 pertaining to the present exemplary embodiment.

First, controller 54 acquires storage medium information from storage medium 531 in storage unit 53 (S600). In order to perform communication with data transmission device 60, controller 54 instructs communication unit 51 to transmit beacon signals (S601). Note that it is beneficial for controller 54 to acquire the storage medium information upon activation of data reception device 50, insertion of storage medium 531, or the like.

When first addition unit 57 acquires a beacon signal transmission instruction from controller 54, first addition unit 57 adds the first additional information and the storage medium information that is acquired from storage medium 531 to the beacon signals (S602). Communication unit 51 transmits the beacon signals to data transmission device 60 (S603).

Then, communication unit 51 receives a connection request signal transmitted from data transmission device 60 (S604).

After communication unit 51 receives the connection request signal, first determination unit 58 determines whether second additional information, which is data transmission device 60-side additional information, is added to the connection request signal (S605). When second additional information is added to the connection request signal (Yes in S605), encryption unit 59 of data reception device 50 encrypts the second additional information (S606). On the other hand, when second additional information is not added to the connection request signal (No in S605), no response is made to the connection request signal.

After the second additional information is encrypted, communication unit 51 transmits, to data transmission device 60, a connection response signal with information yielded by encrypting the second additional information (encryption information) added (S607).

Then, communication unit 51 transitions to a key exchange state (S608). Then, communication unit 51 receives a key exchange request signal (S609). Further, data reception device 50 performs key exchange processing with data transmission device 60 (S610). Note that, when key exchange processing fails, data transmission device 60 transitions to a connection request wait state.

After key exchange processing is completed, data reception device 50 receives data and stores the received data to storage unit 53 (S611).

Then, after the reception of data is completed, data reception device 50 terminates the sequence of processing pertaining to the transmission of beacon signals.

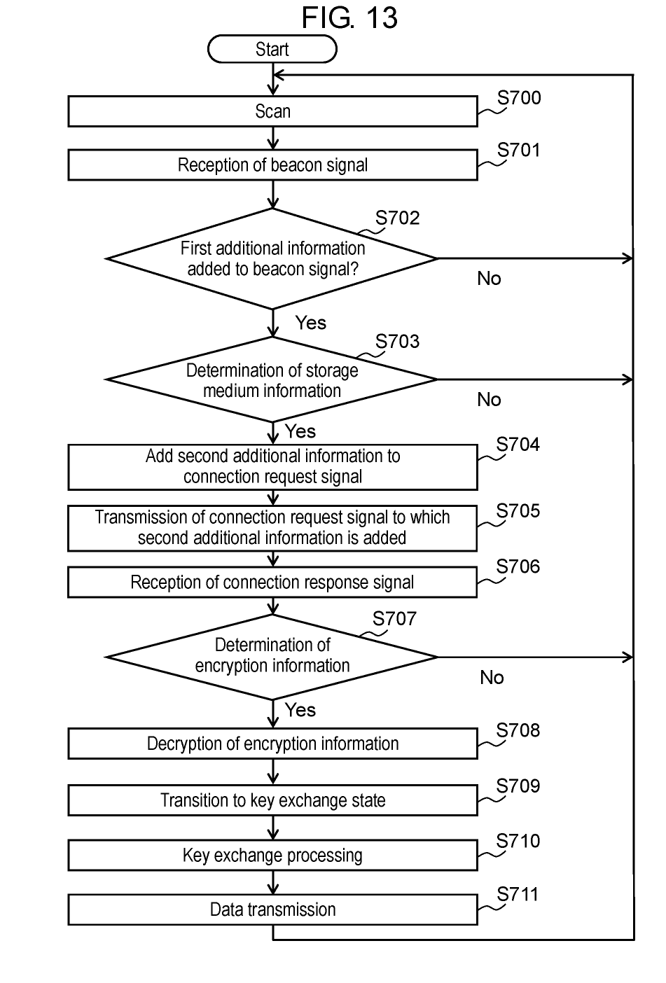

Next, FIG. 13 is a flow diagram illustrating one example of an operation of data transmission device 60 in wireless communication system 3 pertaining to the second exemplary embodiment.

First, controller 64 acquires storage medium information from storage medium 621 in storage unit 62. Then, in order that beacon signals from data reception device 50 can be received at any time, communication unit 63 occasionally performs a scan in order to check whether beacon signals are being transmitted from data reception device 50 (S700). Note that it is beneficial for controller 64 to acquire the storage medium information upon activation of data reception device 50, insertion of storage medium 621, or the like.

Then, data transmission device 60 determines whether or not a beacon signal has been received through the scan (S701). Note that when a beacon signal is not received, data transmission device 60 may perform the scan for receiving a beacon signal again after an interval of time.

When communication unit 63 has received a beacon signal, second determination unit 65 determines whether or not the first additional information is added to the beacon signal (S702). Note that when the first additional information is not added to the beacon signal (No in S702), processing returns to step S700. Then, communication unit 63 performs the scan for receiving a beacon signal again after an interval of time.

Then, when first additional information is added to the beacon signal, second determination unit 65 analyzes the storage medium information in storage medium 531, which is added to the beacon signal. Then, second determination unit 65 determines whether or not the storage medium information in storage medium 531 and the storage medium information in storage medium 621 match (S703). When storage medium information is not added to the beacon signal or the storage medium information added to the beacon signal does not match the storage medium information in storage medium 621 (No in S703), processing returns to step S700. Then, communication unit 63 performs the scan for receiving a beacon signal again after an interval of time.

Then, when the storage medium information added to the beacon signal and the storage medium information in storage medium 531 match (Yes in S703), second addition unit 66 adds the second additional information to a connection request signal (S704). Then, communication unit 63 transmits, to data reception device 50, the connection request signal with the second additional information added (S705).

Then, communication unit 63 receives a connection response signal (S706). Note that when a connection request signal is not received, communication unit 63 may perform the scan for receiving a beacon signal again after an interval of time.

After a connection response signal is received, second determination unit 65 determines whether or not information yielded by encrypting second additional information (encryption information) is added to the connection response signal (S707). When encryption information is not added to the connection response signal (No in S707), communication unit 63 returns to step S700. Then, communication unit 63 performs the scan for receiving a beacon signal again.

Then, when encryption information is added to the connection response signal (Yes in S707), decryption unit 67 decrypts data reception device 50-side additional information (S708). Note that when decryption processing fails, communication unit 63 may perform the scan for receiving a beacon signal again.

After the decryption, data transmission device 60 transitions to a state for performing key exchange processing (S709). Then, data transmission device 60 performs key exchange processing (S710). Note that when key exchange processing fails, communication unit 63 may perform the scan for receiving a beacon signal again.

When key exchange processing succeeds, data transmission device 60 starts transmission of photographic data (S711). Then, the transmission of the photographic data is completed and processing returns to step S700, and communication unit 63 performs the scan again.

### [2-3. Effects, Etc.]

Storage medium 531 is connected to data reception device 50 and storage medium 621 is connected to data transmission device 60 as described in the present exemplary embodiment. By a check being performed of whether the pieces of storage medium information possessed by the respective storage media match, it is possible to prevent connection processing from being performed between data reception device 50 and data transmission device 60 that do not have matching storage medium information. In other words, data reception device 50 may terminate connection processing with data transmission device 60 when the storage medium information in storage medium 531 and the storage medium information in storage medium 621 match. Due to this, it can be ensured that transmission and reception of photographic data can be performed only between specific ones of data reception device 50 and data transmission device 60. Due to this, reliability can be improved.

### Third Exemplary Embodiment

In wireless communication systems 1 and 3 in the first and second exemplary embodiments, exemplary embodiments in surveillance cameras are described. However, these constitute one example. The present disclosure, for example, may be applied to a wireless communication system between cars of a train.

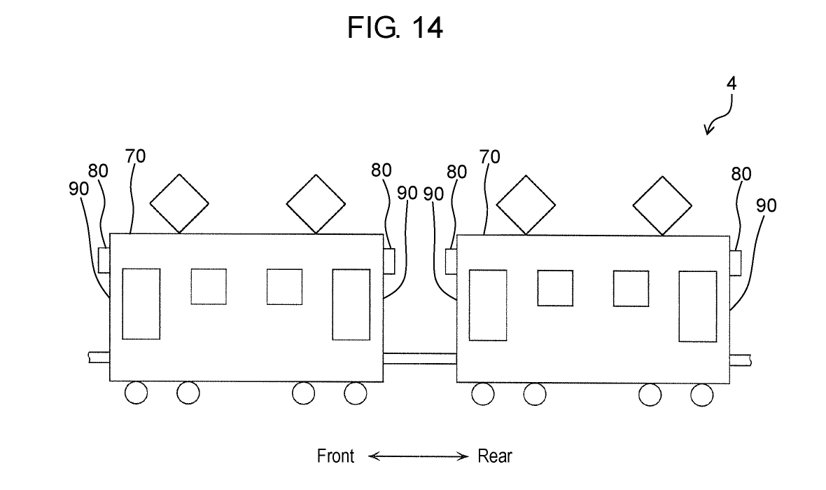

FIG. 14 is a lateral view illustrating one example of an outer appearance of wireless communication system 4 pertaining to the present exemplary embodiment. In FIG. 14, the side of the direction in which cars 70 travel is defined as a front side, and the side opposite from the travel-direction side is defined as a rear side.

As illustrated in FIG. 14, communication devices 80 are provided on opposing surfaces 90 of cars 70. Opposing surfaces 90 are areas at a close distance to one car 70 of two cars 70. Opposing surface 90 of one of cars 70 faces the opposing surface of the other one of cars 70. Opposing surfaces 90 are areas at which cars 70 face one another, and are areas at the rear and front ends of cars 70. Note that, when car 70 is a frontmost car, communication devices 80 may be provided only on opposing surface 90 at the rear end. Note that, when car 70 is a rearmost car, communication devices 80 may be provided on opposing surface 90 at the front end.

Note that cars 70 in the present exemplary embodiment indicate railway cars or the like that are connected with other cars and travel along a track such as a railway track.

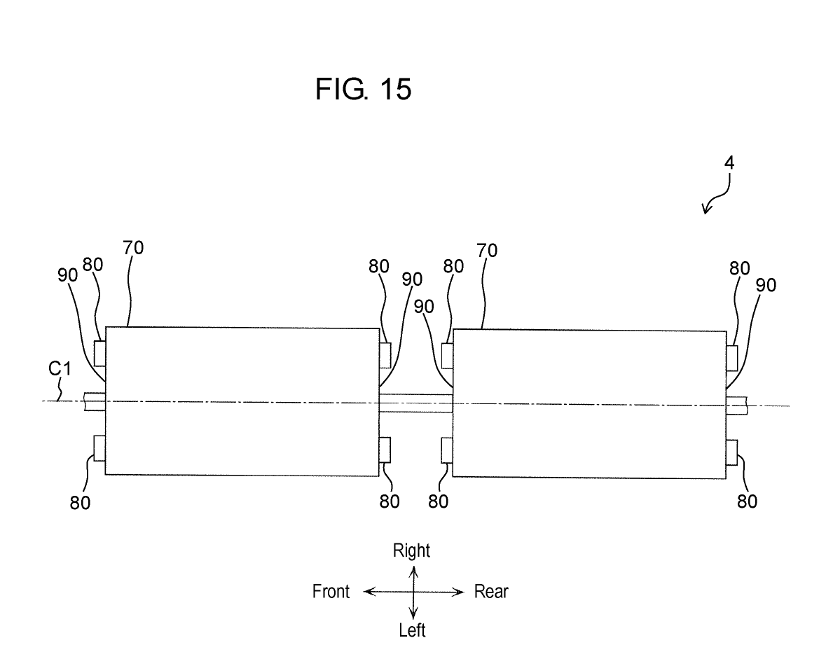

FIG. 15 is a top view illustrating one example of an outer appearance of wireless communication system 4 pertaining to the present exemplary embodiment.

In FIG. 15, the travel-direction side of cars 70 is defined as the front side, and the side opposite from the travel-direction side is defined as the rear side. Further, the right and left sides when facing the travel-direction side of cars 70 are respectively defined as the right and left sides.

Two wireless channels are provided between cars 70 in the present exemplary embodiment as illustrated in FIG. 15, so that the cars can be safely controlled even if a failure such as a malfunction or an erroneous operation occurs. Due to this, at opposing surfaces 90 between cars 70 facing one another, two communication devices 80 are provided on opposing surface 90 of one of cars 70 in wireless communication system 4. Further, two communication devices 80 are provided on opposing surface 90 of the other one of cars 70, at positions opposing two communication devices 80 provided to one of cars 70.

Specifically, the first one of communication devices 80 is provided at the right side of central imaginary line C1 of cars 70 illustrated in FIG. 15. Further, the second one of communication devices 80 is provided at the left side of central imaginary line C1 of cars 70.

As described up to this point, in wireless communication system 4, one communication device 80 provided to one of cars 70 and one communication device 80 provided to the other one of cars 70 are provided at opposing positions. Due to this, wireless communication system 4 has two wireless channels and performs communication between cars 70 by using one of the two wireless channels.

Note that, in the present exemplary embodiment, the number of communication devices 80 provided on opposing surface 90 at one side of each car 70 is two. However, the number of communication devices 80 provided on opposing surface 90 at one side of each car 70 is not limited to two, and may be one or three or more.

Data communication between cars 70 can be performed by adding a configuration similar to that in the first or second exemplary embodiment to this configuration and performing an operation similar to that in the first or second exemplary embodiment.

Note that a photography unit is not necessarily required in wireless communication system 4 between cars 70. Also, data is not limited to photographic data.

Note that an instruction unit is not necessarily required in wireless communication system 4 between cars 70. Further, each communication device 80 may be configured to transmit beacon signals upon activation.

Wireless communication system 4 in the present exemplary embodiment, with respect to two communication devices 80 facing one another, performs a determination of whether or not additional information is added and then performs connection processing. Due to this, erroneous connection of communication device 80 with communication device 80 that does not face communication device 80 can be suppressed.

Due to this, it can be ensured that transmission and reception of data can be performed only between specific devices. Due to this, reliability can be improved.

### Fourth Exemplary Embodiment

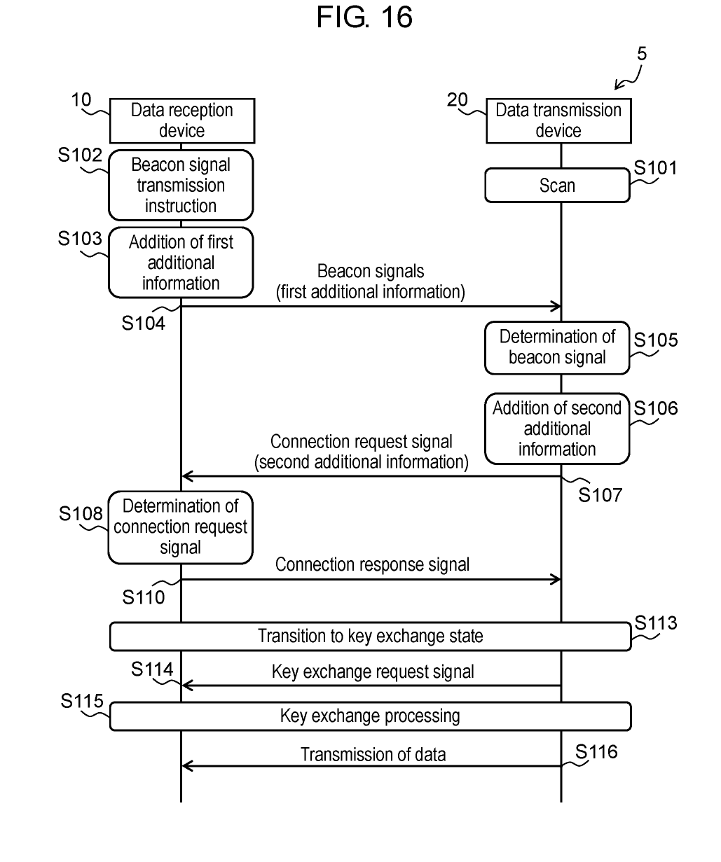

An operation of wireless communication system 5 pertaining to the fourth exemplary embodiment is described with reference to FIG. 16. Note that, in the present exemplary embodiment, constituent elements and operations similar to those in the first exemplary embodiment are provided with the same reference signs as those provided in the first exemplary embodiment.

FIG. 16 is a sequence diagram illustrating one example of an operation of wireless communication system 5 pertaining to the fourth exemplary embodiment. Wireless communication system 5 includes data reception device 10, data transmission device 20, and photography device 21 (see FIG. 1). The sequence illustrated in FIG. 16 differs from the sequence illustrated in FIG. 4 for not including the operations in step S109, step S111, and step S112. Accordingly, data reception device 10 pertaining to the present exemplary embodiment need not include encryption unit 19 (see FIG. 2). Similarly, data transmission device 20 pertaining to the present exemplary embodiment need not include decryption unit 27 (see FIG. 3).

The sequence pertaining to the present exemplary embodiment is described below.

Data reception device 10 and data transmission device 20 perform the operations from step S101 to step S108. After the operation in step S108, data reception device 10 transmits a connection response signal to data transmission device 20 without encrypting second additional information (S110). That is, in the present exemplary embodiment, encrypted second additional information is not added to the connection response signal.

Data transmission device 20, having received the connection response signal, transitions to a key exchange state (S113). That is, data transmission device 20 transmits a key exchange request signal to data reception device 10 (S114). Then, data reception device 10 and data transmission device 20 perform the operations in step S115 and step S116 similarly to those in the first exemplary embodiment.

As described up to this point, wireless communication system 5 pertaining to the present disclosure performs transmission and reception of data without encrypting second additional information and decrypting encrypted second additional information. Even with such a configuration, reliability in wireless communication can be improved because beacon signals are transmitted from data reception device 10 possessed by a user.

### Other Exemplary Embodiments

The order in which operations are performed is not limited to those in the first to third exemplary embodiments.

For example, in the second exemplary embodiment, data transmission device 60 determines whether or not the first additional information is added to a beacon signal transmitted from data reception device 50. Then, data transmission device 60 determines whether or not the storage medium information added to the beacon signal and the storage medium information in storage medium 621 included in data transmission device 60 match. However, data transmission device 60 may check whether or not the storage medium information added to the beacon signal transmitted from data reception device 50 and the storage medium information in storage medium 621 included in data transmission device 60 match, and analyze whether or not the first additional information is added to the beacon signal when the two pieces of storage medium information match.

Further, in the second exemplary embodiment, controller 64 checks whether or not the storage medium information of storage medium 531 included in a beacon signal and the storage medium information of storage medium 621 having been acquired from storage unit 62 match. However, the present disclosure is not limited to this. Storage medium 621 need not be connected to storage unit 62. Instead, storage unit 62 may store information regarding storage medium 531. In this case, second determination unit 65 acquires information regarding storage medium 531 included in a beacon signal. Then, second determination unit 65 determines whether or not the information regarding storage medium 531 that is acquired and the information (storage medium information) regarding storage medium 531 that storage unit 62 of data transmission device 60 has match. Then, when the information regarding storage medium 531 and the storage medium information that data transmission device 60 has match, communication unit 63 may transmit photographic data to data reception device 50. Further, data reception device 50 may terminate connection processing with data transmission device 60 when the information regarding storage medium 531 and the storage medium information that data transmission device 60 has do not match. Reliability in wireless communication can be improved even with such a configuration.

Further, with regard to the beacon signals in the first to third exemplary embodiments, the beacon signals are constantly transmitted and received until data communication is terminated. Due to this, transmission of beacon signals may be performed always with the first additional information added to the beacon signals. Similarly, in the second exemplary embodiment, transmission of beacon signals may be performed always with the storage medium information also added to the beacon signals in addition to the first additional information. For example, in the first exemplary embodiment, data reception device 10 may transmit beacon signals always with the first additional information added to the beacon signals when data reception device 10 transmits the beacon signals to data transmission device 20.

Further, in the wireless communication in the first to third exemplary embodiments, it is more preferable to adopt a configuration such that only one-to-one data communication is possible. For example, in the first exemplary embodiment, it is more preferable to adopt a configuration such that data reception device 10 and data transmission device 20 are only capable of performing one-to-one data communication. By adopting such a configuration, it is possible to suppress erroneous connection with other data reception devices 10 with which data transmission device 20 does not desire to communicate.

Further, in wireless communication system 1 in the first exemplary embodiment, data reception device 10 includes encryption unit 19 and data transmission device 20 includes decryption unit 27. However, the wireless communication system pertaining to the present disclosure is not limited to this configuration. In the wireless communication system pertaining to the present disclosure, it may be the data transmission device that includes the encryption unit and it may be the data reception device that includes the decryption unit. In this case, the encryption unit of the data transmission device encrypts first additional information, and the decryption unit of the data reception device decrypts the encrypted first additional information and generates decrypted information. Then, the first determination unit determines whether or not the first additional information having been added to beacon signals and the decrypted information match. When the pieces of information match, the first determination unit authenticates the connection request signal with the encrypted first additional information added. Reliability in wireless communication can be improved even with such a configuration.

As described up to this point, the first to fourth exemplary embodiments have been described as examples of the technique in the present disclosure. The accompanying drawings and the detailed description are provided for this purpose.

Therefore, in order to exemplify the above technique, the constituent elements described in the accompanying drawings and the detailed description not only include components that are essential for solving the problem but also may include constituent elements that are not essential for solving the problem. Therefore, it should not be immediately construed that these constituent elements that are not essential are essential just because the constituent elements are described in the accompanying drawings and the detailed description.

Further, because the above exemplary embodiments are for exemplifying the technique in the present disclosure, various modifications, replacements, additions, omissions, and the like can be made without departing from the scope of the claims and equivalents thereof.

### INDUSTRIAL APPLICABILITY

The present disclosure is applicable to wireless communication systems in which transmission and reception of data are performed, such as a surveillance camera, a communication system between railway cars, etc.

### REFERENCE MARKS IN THE DRAWINGS

1, 2, 3, 4, 5: wireless communication system
10, 30, 50: data reception device (first wireless communication device)
11, 51: communication unit (first communication unit)
12, 52: instruction unit
13, 22, 53, 62: storage unit
14, 24, 54, 64: controller
15, 55: selection unit
16, 56: display unit
17, 57: first addition unit
18, 58: first determination unit
19, 59: encryption unit
20, 40, 60: data transmission device (second wireless communication device)
21: photography device
23, 63: communication unit (second communication unit)
25, 65: second determination unit
26, 66: second addition unit
27, 67: decryption unit
61: photography unit
70: car
80: communication device
90: opposing surface
531: storage medium (first storage medium)
621: storage medium (second storage medium)

1. A wireless communication system comprising:
a first wireless communication device that receives data; and
a second wireless communication device that transmits the data,
wherein the first wireless communication device includes:
a first communication unit that wirelessly communicates with the second wireless communication device; and
a first addition unit that adds first additional information to a connection signal for performing connection,
the second wireless communication device includes:
a second communication unit that wirelessly communicates with the first wireless communication device; and
a second addition unit that adds, to a connection request signal requesting connection with the first wireless communication device, second additional information differing from the first additional information,
the second communication unit transmits to the first wireless communication device the connection request signal with the second additional information added when the second communication unit receives from the first communication unit the connection signal with the first additional information added, and
the first communication unit transmits to the second wireless communication device a connection response signal for responding to the connection request signal and receives the data from the second wireless communication device when the first communication unit receives from the second communication unit the connection request signal with the second additional information added.

2. The wireless communication system according to claim 1, wherein
the first additional information is specific information that the first wireless communication device has, and
the second additional information is specific information that the second wireless communication device has.

3. The wireless communication system according to claim 1, wherein
the first wireless communication device includes an encryption unit,
the second wireless communication device includes a decryption unit,
the encryption unit encrypts the second additional information added to the connection request signal,
the first addition unit adds the encrypted second additional information to the connection response signal,
the first communication unit transmits to the second wireless communication device the connection response signal with the encrypted second additional information added,
the decryption unit decrypts the encrypted second additional information and generates decrypted information, and
the second communication unit transmits the data to the first wireless communication device when the second additional information added by the second addition unit matches the decrypted information generated by the decryption unit.

4. The wireless communication system according to claim 3, wherein
the second communication unit transmits a key exchange request signal to the first wireless communication device when the second additional information added by the second addition unit and the decrypted information generated by the decryption unit match, and
the second wireless communication device does not accept any signals from devices other than the first wireless communication device from when transmission of the key exchange request signal is started until when transmission of the data is completed.

5. The wireless communication system according to claim 1, wherein
the first wireless communication device includes an instruction unit that accepts a user instruction, and
the first communication unit transmits a beacon signal to the second wireless communication device as the connection signal when the instruction unit accepts a user instruction.

6. The wireless communication system according to claim 1, wherein
the first wireless communication device is connected to a storage medium, and
the second communication unit transmits the data to the first wireless communication device when information regarding the storage medium and storage medium information that the second wireless communication device has match.

7. The wireless communication system according to claim 6, wherein the first wireless communication device terminates connection processing with the second wireless communication device when the information regarding the storage medium and the storage medium information do not match.

8. The wireless communication system according to claim 1, wherein
the second wireless communication device is connected to a photography device,
the data is photographic data photographed by the photography device, and
the second communication unit receives the photographic data from the photography device and transmits the photographic data to the first wireless communication device.

9. The wireless communication system according to claim 1, wherein the first communication unit and the second communication unit wirelessly communicate by using a wireless communication method having directivity.

10. A wireless communication device that receives data from a data transmission device, the wireless communication device comprising:
a communication unit that wirelessly communicates with the data transmission device; and
an addition unit that adds first additional information to a connection signal for performing connection, wherein
when the communication unit transmits the connection signal with the first additional information added and subsequently receives from the data transmission device a connection request signal with second additional information added, the second additional information differing from the first additional information, the communication unit transmits to the data transmission device a connection response signal for responding to the connection request signal and receives the data from the data transmission device.

11. The wireless communication device according to claim 10, further comprising an instruction unit that accepts a user instruction, wherein
the communication unit transmits a beacon signal to the data transmission device as the connection signal when the instruction unit accepts a user instruction.

12. A wireless communication device that transmits data to a data reception device, comprising:
a communication unit that wirelessly communicates with the data reception device; and
an addition unit that adds second additional information to a connection request signal requesting connection with the data reception device, wherein
the communication unit transmits to the data reception device the connection request signal with the second additional information added by the addition unit when the communication unit receives from the data reception device a connection signal with first additional information added, the first additional information differing from the second additional information, and
the communication unit transmits the data to the data reception device when the communication unit receives from the data reception device a connection response signal for responding to the connection request signal.
